(19) United States
(12) Patent Application Publication
(10) Pub. No.: US 2021/0089992 A1
(43) Pub. Date: Mar. 25, 2021

(54) METHOD FOR AUTOMATED CODE REVIEWER RECOMMENDATION

(71) Applicant: NEC Laboratories America, Inc., Princeton, NJ (US)

(72) Inventors: Jianwu Xu, Titusville, NJ (US); Ding Li, Franklin Park, NJ (US); Wei Cheng, Princeton Junction, NJ (US); Haifeng Chen, West Windsor, NJ (US)

(21) Appl. No.: 17/016,709

(22) Filed: Sep. 10, 2020

Related U.S. Application Data
(60) Provisional application No. 62/903,004, filed on Sep. 20, 2019.

(51) Int. Cl. G06Q 10/06; G06K 9/62; G06N 3/08

(52) U.S. Cl. CPC G06Q 10/06398; G06N 3/08; G06K 9/6215; G06Q 10/063112

(57) ABSTRACT

A method for automatically recommending a reviewer for submitted codes is presented. The method includes employing, in a learning phase, an artificial intelligence agent for learning an underlying and contextual structure of code regions, mapping the code regions into a distributed representation to define code region representations, employing, in a recommendation phase, the artificial intelligence agent to produce a ranked list of recommended reviewers for any given submitted code review request, and outputting the ranked list of recommended reviewers to a visualization device.

### RELATED APPLICATION INFORMATION

This application claims priority to Provisional Application No. 62/903,004, filed on Sep. 20, 2019, the contents of which are incorporated herein by reference in their entirety.

### BACKGROUND

### Technical Field

The present invention relates to code review and, more particularly, to methods and systems for automatically recommending a reviewer for submitted codes to be checked.

### Description of the Related Art

Modern software development life cycle (SDLC) includes several stages, that is, requirement gathering and analysis, architecture design analysis, source code implementation, various types of testing, product/solution deployment, and maintenance and customer support. The stage of source code implementation is where ideas and designs are realized in the format of computer programming languages. This stage is usually performed by a team of software engineers working together. This stage includes multiple rounds of code programming and code review. There are multiple purposes for the code review process. First purpose is to check the correctness which may be overlooked by the original author. Second purpose is the code maintainability which confirms the codes to the organization's standard. This is important because during the late stage of maintenance and customer support in SDLC, the responsible party may fall into non-original authors of the source code. Therefore, it is beneficial for the source code to be in the standard format according to the organization's requirement so that a code maintainer can handle any subsequent support issues quickly.

### SUMMARY

A computer-implemented method for automatically recommending a reviewer for submitted codes is presented. The method includes employing, in a learning phase, an artificial intelligence agent for learning an underlying and contextual structure of code regions, mapping the code regions into a distributed representation to define code region representations, employing, in a recommendation phase, the artificial intelligence agent to produce a ranked list of recommended reviewers for any given submitted code review request, and outputting the ranked list of recommended reviewers to a visualization device.

A non-transitory computer-readable storage medium comprising a computer-readable program is presented for automatically recommending a reviewer for submitted codes, wherein the computer-readable program when executed on a computer causes the computer to perform the steps of employing, in a learning phase, an artificial intelligence agent for learning an underlying and contextual structure of code regions, mapping the code regions into a distributed representation to define code region representations, employing, in a recommendation phase, the artificial intelligence agent to produce a ranked list of recommended reviewers for any given submitted code review request, and outputting the ranked list of recommended reviewers to a visualization device.

A system for automatically recommending a reviewer for submitted codes is presented. The system includes a memory and one or more processors in communication with the memory configured to employ, in a learning phase, an artificial intelligence agent for learning an underlying and contextual structure of code regions, map the code regions into a distributed representation to define code region representations, employ, in a recommendation phase, the artificial intelligence agent to produce a ranked list of recommended reviewers for any given submitted code review request, and output the ranked list of recommended reviewers to a visualization device.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary software development life cycle (SDLC), in accordance with embodiments of the present invention;

FIG. 2 is a block/flow diagram of exemplary software implementation stages, in accordance with embodiments of the present invention;

FIG. 3 is a block/flow diagram of exemplary code review stages, in accordance with embodiments of the present invention;

FIG. 4 is a block/flow diagram of exemplary components for selecting a reviewer, in accordance with embodiments of the present invention;

FIG. 5 is a block/flow diagram of exemplary components of code region representation, in accordance with embodiments of the present invention;

FIG. 6 illustrates an example of a code region and corresponding code line templates, in accordance with embodiments of the present invention;

FIG. 7 is a block/flow diagram of an exemplary processing system for automatically recommending a reviewer for submitted codes, in accordance with embodiments of the present invention;

FIG. 8 is a block/flow diagram of an exemplary method for automatically recommending a reviewer for submitted codes, in accordance with embodiments of the present invention;

FIG. 9 is a block/flow diagram of equations employed in an exemplary method for automatically recommending a reviewer for submitted codes, in accordance with embodiments of the present invention; and

FIG. 10 is a block/flow diagram of a practical application for automatically recommending a reviewer for submitted codes, in accordance with embodiments of the present invention.

### DETAILED DESCRIPTION OF PREFERRED EMBODIMENTS

The code review stage starts when the original developer prepares a set of source code to be reviewed. The set of source code may include multiple source code files, or just several methods or functions, or some bug fixes, etc. Then the code author sends the review request to the intended reviewer. The reviewer may be a senior architect or developer who is familiar with the set of source code to be reviewed. Then the submitter and reviewer work together to go through multiple rounds of review and improvement. Finally, once the process finishes, the improved and corrected source code is checked into a common code repository hosted via a version control system. The version control system may automate the storing, retrieving, logging, and other development processes. The version control system may include, e.g., Git, Concurrent Versions System (CVS), and other commercial or open-source software. Git is a free and open source distributed version control system designed to handle everything from small to very large projects with speed and efficiency. CVS is a free client-server revision control system in the field of software development. A version control system keeps track of all work and all changes in a set of files and allows several developers to collaborate.

One key challenge in the code review process is how to choose the right person to review the source codes. Because for a large organization there may be multiple teams working together towards the same product or solution, codes written by a developer from one team may be related to the ones authored from another team. If the code reviewer is always chosen from the same team, then the reviewer may not get the full information. On the other hand, if the code reviewer is selected from members of non-relevant teams, then the reviewer may not have the relevant knowledge to provide the most accurate opinion. Therefore, the reviewer is required to have a right balance of knowledge about the codes in order to offer the best results.

Conventionally, the selection of the reviewer is based on the seniority of team members. Usually a design architect is chosen to review junior developers' codes because the software architect understands different components of the software. However, it would be costly if the highly paid software architect is always chosen to review junior programmers' codes. Relevance-based selection has also been proposed based on the ranking scores of each code reviewers' history. Then a top ranked reviewer is selected based on individual's review history which is relevant to the codes. However, this approach tends to select reviewers who have a high number of reviews and may ignore the quality of the reviews.

The exemplary embodiments of the present invention introduce a method capable of automatically recommending the reviewer for the submitted codes to be checked. The recommendation is based on the review history, coding style and commit history, and employment position of each individual reviewer across different development teams. This set of multiple sources of information is used to train the model so that the model is able to find the most relevant reviewer given the set of submitted code review requests. A deep learning embedding is used to represent the code for subsequent similarity computation. This representation is able to extract the contextual information of the codes within the software component.

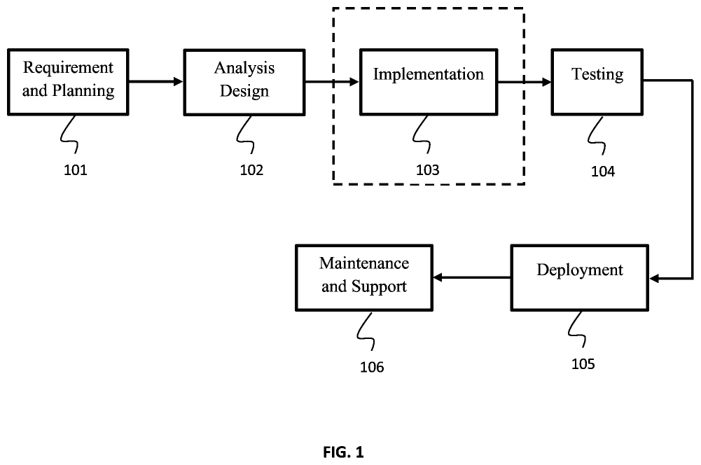

FIG. 1 presents the components in a conventional software development life cycle (SDLC). The SDLC starts with the software requirement analysis and planning for the development 101. The requirements originate from the business purpose of the final solution or product. Then the SDLC proceeds to the analysis design 102 which includes, but is not limited to, software architecture design, programming language selection, software development environment selection, and many others. Once the design 102 is done, the next stage is implementation 103, which materializes the software product in a suite of programming languages. Once the implementation 103 is done, software testing 104 is applied to ensure the quality and correctness of the product. If the product passes the testing, the product is deployed and shipped to one or more customer sites 105. Ongoing maintenance and support 106 are provided to customers for continuing improvements and satisfaction.

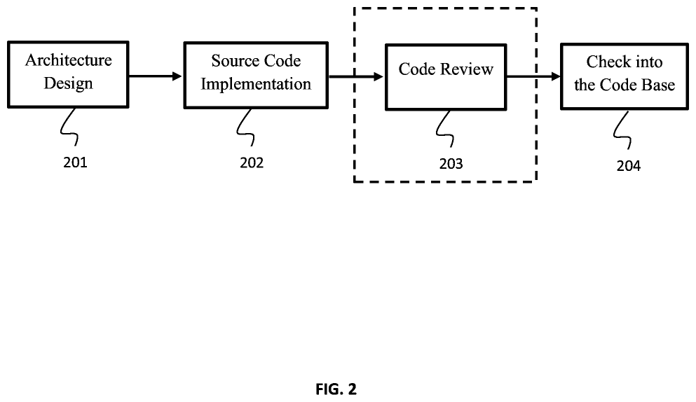

The software implementation 103 component in SDLC includes multiple stages as shown in FIG. 2. The software implementation 103 starts with the architecture design 201, which lays down the foundation of the software. The architecture design 201 is usually designed by the senior architect who determines the workflow, service model, and connection of each different application programming interface (API), etc. Once the design stage 201 is complete, the process moves to the source code implementation block 202. Each team is tasked with a different software component and realizes such software components in a chosen programming language. The component 203 starts the code review process for each software component to ensure the code maintainability and to reduce coding mistakes. If the software component passes the code review process, it checks into the code base 204 and moves to the next stage in the SDLC.

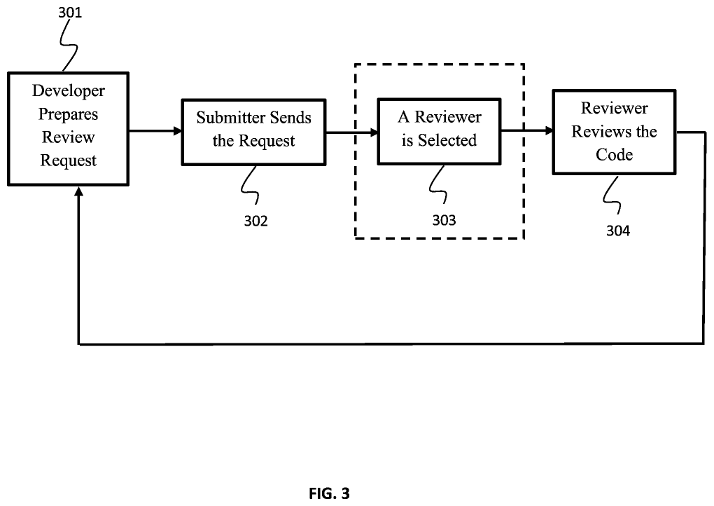

FIG. 3 illustrates the sequential steps within the code review component 203. The original software developer prepares a set of codes to be reviewed 301. This can include multiple source code files, configure files, commit history, etc. Then the developer submits the request 302 to the team collaboration environment such as Microsoft's Visual Studio Team Foundation, or other project management software. The developer may manually select a reviewer from the collaboration environment, or it may be automatically chosen based on certain criterion 303. The selected reviewer examines the submitted codes and starts the corrections, comments or questions 304. This feedback is provided back to the original submitter and the submitter modifies and improves the original source codes based on the comments from the reviewer. Then this procedure starts over again until all the modifications are finished and both parties agree on the final version.

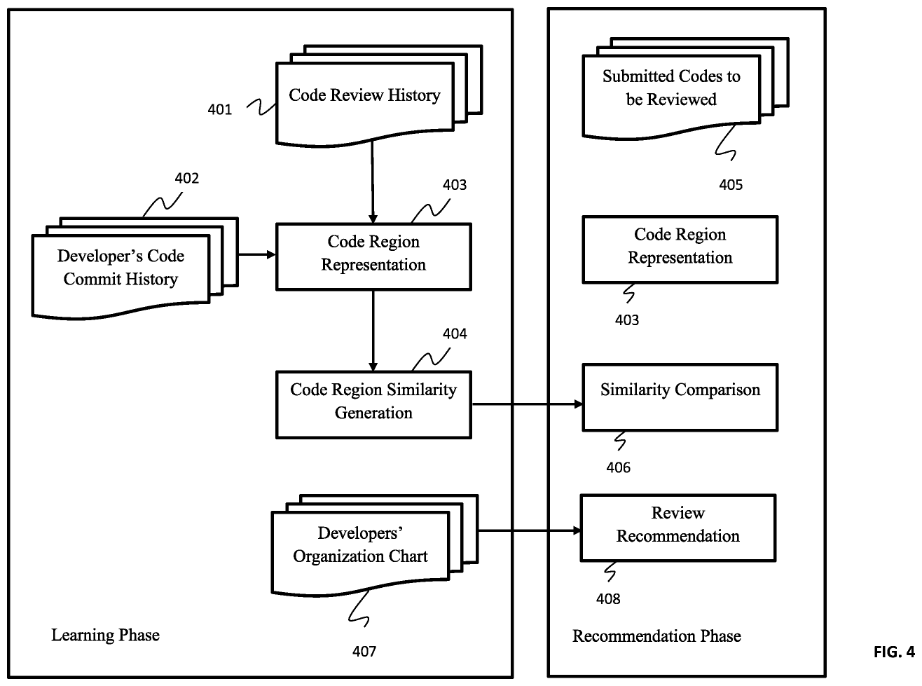

FIG. 4 illustrates the overall workflow of the present invention which automatically selects the most relevant reviewer given a set of submitted codes. The workflow includes two phases, the learning phase and the recommendation phase. The learning phase is the phase when an artificial intelligence (AI) agent learns the underlying and contextual structure of code regions and maps the code regions into a distributed representation so that they will be used for subsequent similarity search. The recommendation phase is when the AI agent produces a ranked list of recommended reviewers for any given submitted code review request.

Regarding code review history 401, one of the inputs to the component 403 is the code review history 401. The code review history 401 includes metadata information such as which reviewer reviews certain portion of code regions, what amount of source codes are reviewed by a particular reviewer, how many rounds of feedback and improvements for each review have taken place, etc. This information is used by component 403 to produce the representation for each reviewer.

Regarding the developers' code commit history 402, this set of information is used to represent reviewers' own expertise in different software modules. Some reviewers may be programming database modules, and at the same time reviewing source codes from front-end applications. Because there is a connection between the backend database and the front-end applications, this particular reviewer has the unique position of understanding both set of source codes and can be the ideal candidate to review the front-end source codes. The code commit history includes meta information such as which software modules or components were written by a particular reviewer and their revision history, frequency and temporal information of each commit, etc. This information is extracted and used for the generation of each developer's expertise and knowledge level.

Regarding code region representation 403, the inputs of 401 and 403 are required to convert to a compact representation so that each of the different code regions can be compared.

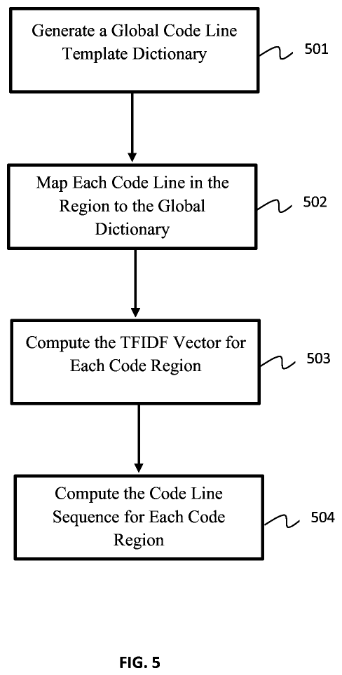

FIG. 5 presents the different components within 403.

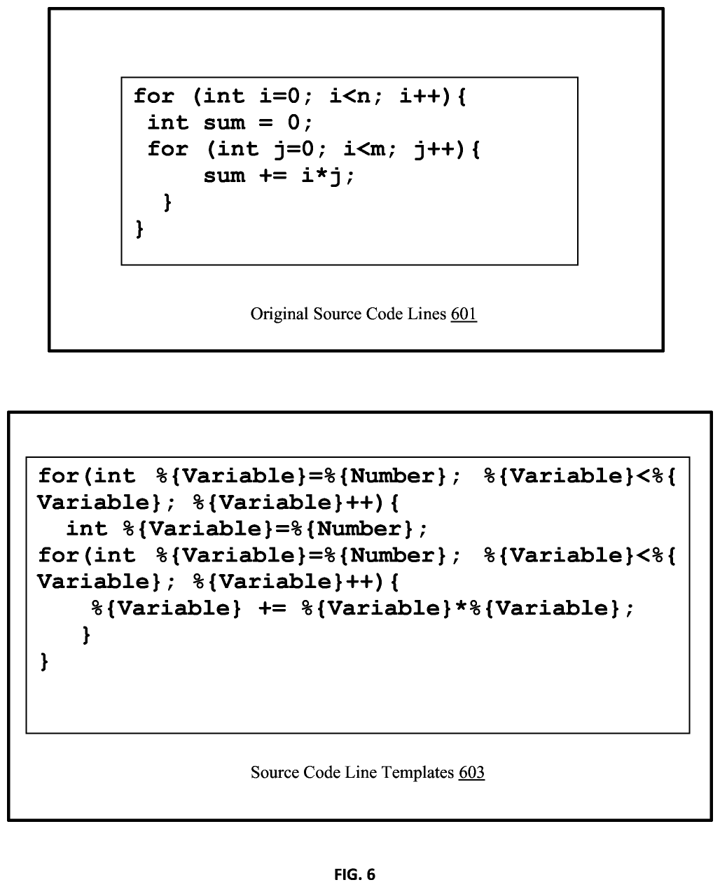

Regarding the generate a global code line template dictionary 501, in order to compare different code regions so that code reviewers' activities can be compared and normalized, the first step is to create a global dictionary for each code line. Code line stands for each line of source code. This component takes the entirety of the code repository to learn the complete code line template. The template is defined as the generating pattern of each source code line. FIG. 6 illustrates one example of the original source code 601 and its corresponding code line template 603. This component automatically generates the code line template. Each code line template is assigned a unique ID.

Regarding the map each code line in the region to the global dictionary 502, once the global code line template dictionary is generated, 502 maps each code line into its own unique template ID. Therefore, each source code line has been transformed into a comparable base so that their similarity can be compared.

Regarding the compute the TFIDF vector for each code region 503, each code region is transformed into a vector where the element is the calculation of TFIDF (term-frequency inverse document frequency) value of each code line template.

The TFIDF is defined as:

for each code line template i, it is computed as follows:

TF-IDFᵢ=Pᵢ−IDFᵢ

Where Pᵢ is the frequency of code line template i in the overall code region and IDFᵢ is the inverse document frequency for code line template i.

It is defined as:

$${IDF}_{i} = log \frac{Total number of code regions}{Number of code regions with template i in it}$$

Regarding the compute the code line sequence for each code region 504, the exemplary embodiments of the present invention employ two types of similarity features. One is computed in 503 as a TDIDF feature, which characterizes the code line template distributions, and the other one is the code line template sequences. The code line template sequence specifies the code transition. The automated sequence extracted is applied in 504 to generate the code line template flow order.

Regarding the code region similarity generation 404, two sets of similarity measures are generated. The first similarity measure is used to compute the cosine distance between any two TFIDF vectors. This similarity measure computes the content similarity based on the code line templates. The exemplary embodiments of the present invention use cosine distance to measure the similarity between two TFIDF vectors.

Given two TFIDF vectors, A and B, the cosine similarity, cos(θ), is represented using a dot product and magnitude as:

$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

Where each Aᵢ and Bᵢ are the TFIDF values within a particular code region. Because TFIDFs are positive numbers, the value of cos(θ) ranges between 0 and 1 with 0 being least similar and 1 being identical.

The second similarity measure is based on the code line template sequence similarity. The second similarity measure measures the structure similarity between any two code regions. The sequence similarity is based on the method of Smith-Waterman algorithm, which generates a distance value to describe the sequences similarity.

Regarding submitted codes to be reviewed 405, this is the set of source code files submitted by the developer who requests the code review. The requestor organizes the source code files and submits them to the team collaborating environment.

Regarding the similarity comparison 406, the source codes files to be reviewed pass through component 403 to generate the distributed representation based on code line templates and structure sequence. Similarity comparison 406 generates a TFIDF vector for the code files 405 and the code template sequence. There are multiple TFIDF vectors associated with each reviewer because they have committed multiple source codes and reviewed different software modules. Therefore, the TFIDF vector for the source code to be reviewed 405 is compared against each of the TFIDF vectors associated with each reviewer based on the cosine distance defined in 404. The final similarity based on TFIDF is aggregated into a normalized value for each reviewer. The same procedure is performed for the similarity measure based on the code line template sequence and aggregated into a final normalized value. The total similarity measure between the code region to be reviewed and each developer is the average of the two aforementioned similarity distances.

Regarding the developers' organization chart 407, while the developer's source code commit history 402 and manual review activities 401 represent the developer's expertise, knowledge and experience, the developer's employment position within the company describes the seniority. As an ideal reviewer candidate should have both the right expertise and diversified employment position, the exemplary embodiments of the present invention employ the organization's position chart to extract the relevant information. The organization chart is represented as a tree chart.

The distance between the developer who submits the code review request and any reviewer candidate is based on a tree path metric, which is defined as follows:

$${s}_{i} ( {v}_{i} , {v}_{j} ) = \frac{1}{1 + l ( {v}_{i} , {v}_{j} )} = \frac{1}{1 + l ( {v}_{i} , {lca}_{ij} ) + l ( {v}_{j} , {lca}_{ij} )} .$$

Where vᵢ and vⱼ represent two developers, l(vᵢ, vⱼ) is a shortest path between two developers in the organization tree chart, and lcaᵢⱼ is a lowest common ancestor between vᵢ and vⱼ.

Regarding the review recommendation 408, the final reviewer recommendation score is a convex combination of 406 and 407 as shown in the following equation:

Q(vᵢ,vᵢ)=(1−α)S(vᵢ,vⱼ)+α0(vᵢ,vⱼ)

Where S(v₁, v₁) is the similarity distance based on the developer's organization chart from 407 and O(vᵢ, vⱼ) is the similarity distance based on the reviewer's expertise calculated from 406. Based on the score, 408 recommends a list of reviewers with high Q(vᵢ, vⱼ) values. The developer who submits the review request can choose a candidate from the list.

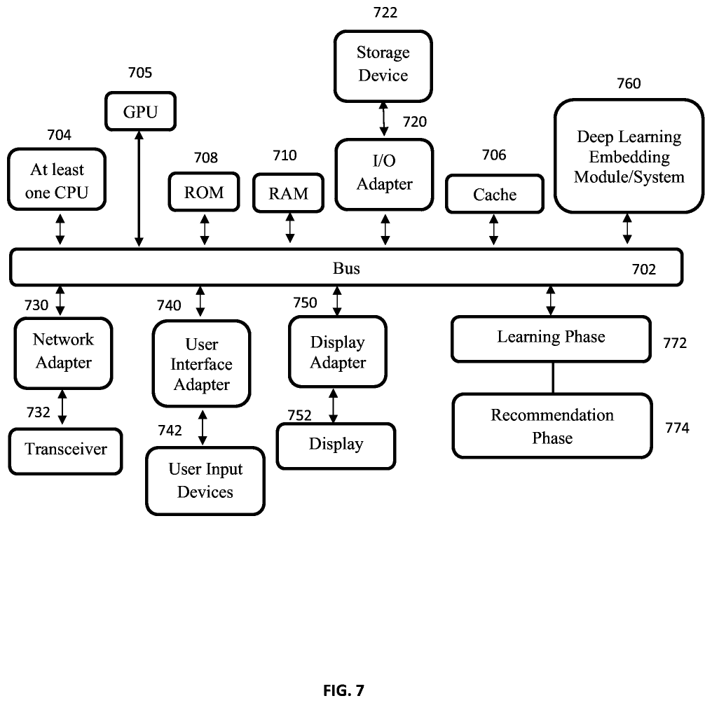

FIG. 7 is block/flow diagram of an exemplary processing system for automatically recommending a reviewer for submitted codes, in accordance with embodiments of the present invention.

The processing system includes at least one processor or processor device (CPU) 704 and a graphics processing unit (GPU) 705 operatively coupled to other components via a system bus 702. A cache 706, a Read Only Memory (ROM) 708, a Random Access Memory (RAM) 710, an input/output (I/O) adapter 720, a network adapter 730, a user interface adapter 740, and a display adapter 750, are operatively coupled to the system bus 702. Deep learning embedding module/system 760 can be employed via the bus 702. Deep learning embedding module/system 760 can employ a learning phase 772 and a recommendation phase 774 to automatically recommend a reviewer for submitted codes.

A storage device 722 is operatively coupled to system bus 702 by the I/O adapter 720. The storage device 722 can be any of a disk storage device (e.g., a magnetic or optical disk storage device), a solid state magnetic device, and so forth.

A transceiver 732 is operatively coupled to system bus 702 by network adapter 730.

User input devices 742 are operatively coupled to system bus 702 by user interface adapter 740. The user input devices 742 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 742 can be the same type of user input device or different types of user input devices. The user input devices 742 are used to input and output information to and from the processing system.

A display device 752 is operatively coupled to system bus 702 by display adapter 650.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, processor devices, controllers, memories, and so forth, in various configurations can also be utilized as readily appreciated by one of ordinary skill in the art. These and other variations of the processing system are readily contemplated by one of ordinary skill in the art given the teachings of the present invention provided herein.

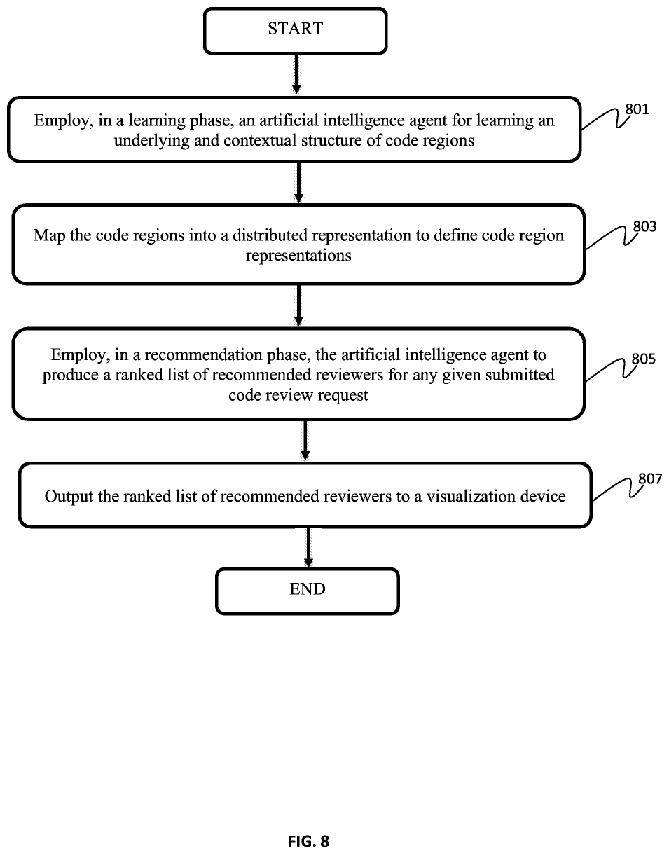

FIG. 8 is a block/flow diagram of an exemplary method for automatically recommending a reviewer for submitted codes, in accordance with embodiments of the present invention.

At block 801, employ, in a learning phase, an artificial intelligence agent for learning an underlying and contextual structure of code regions.

At block 803, map the code regions into a distributed representation to define code region representations.

At block 805, employ, in a recommendation phase, the artificial intelligence agent to produce a ranked list of recommended reviewers for any given submitted code review request.

At block 807, output the ranked list of recommended reviewers to a visualization device.

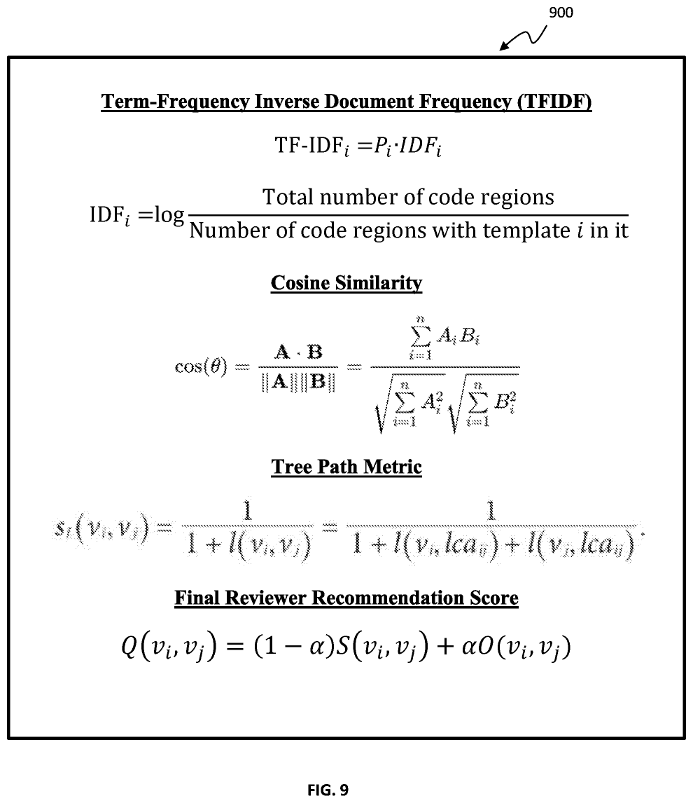

FIG. 9 is a block/flow diagram of equations employed in methods for automatically recommending a reviewer for submitted codes, in accordance with embodiments of the present invention.

Equations 900 identify term-frequency inverse document frequency (TFIDF), cosine similarity, a tree path metric, and a final reviewer recommendation score.

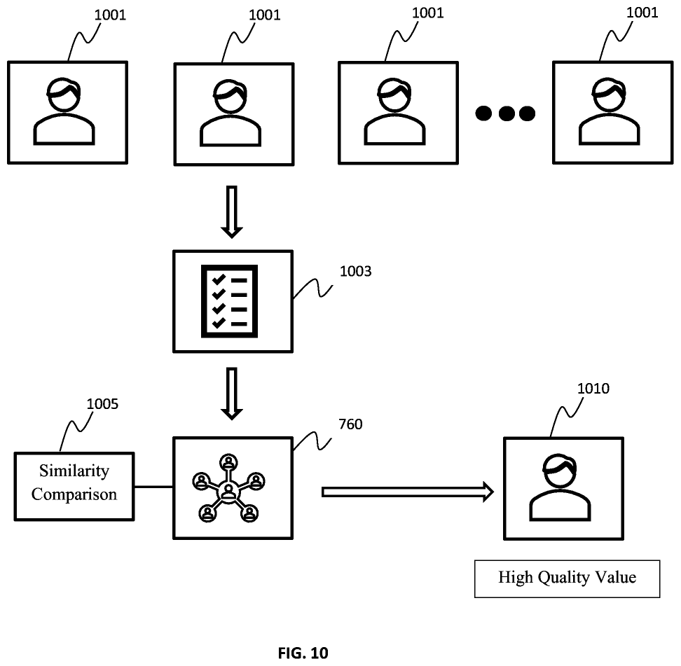

FIG. 10 is a block/flow diagram of a practical application for automatically recommending a reviewer for submitted codes, in accordance with embodiments of the present invention.

A plurality of candidate reviewers 1001 can be employed to review source code 1003. A deep learning embedding module/system 760 is used to represent the source code 1003 for similarity computation 1005. This representation is able to extract the contextual information of the source code 1003 within the software component. The deep learning embedding module/system 760 enables the selection of a reviewer 1010 from the plurality of candidate reviewers 1001 for review of the source code 1003.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method executed on a processor for automatically recommending a reviewer for submitted codes, the method comprising:
employing, in a learning phase, an artificial intelligence agent for learning an underlying and contextual structure of code regions;
mapping the code regions into a distributed representation to define code region representations;
employing, in a recommendation phase, the artificial intelligence agent to produce a ranked list of recommended reviewers for any given submitted code review request; and
outputting the ranked list of recommended reviewers to a visualization device.

2. The method of claim 1, wherein the ranked list of recommended reviewers is based on code review history, coding style, commit history, and employment position of each candidate reviewer.

3. The method of claim 2, wherein the code review history includes metadata information including select code regions reviewed, amount of source codes reviewed, and feedback and improvement rounds.

4. The method of claim 1, wherein the code region representations include generating a global code line template dictionary.

5. The method of claim 4, wherein each code line of a code region is mapped to the global code line template dictionary.

6. The method of claim 5, wherein a term-frequency inverse document frequency (TFIDF) vector is computed for each code region.

7. The method of claim 6, wherein two sets of similarity measures are generated, the first similarity measure employed to compute a cosine distance between any two TFIDF vectors and a second similarity measure employed to compute a content similarity based on code line templates.

8. The method of claim 7, wherein the cosine distance is given as:
$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$
where each Aᵢ and Bᵢ are TFIDF values within a particular code region.

9. The method of claim 8, wherein an organization chart is employed in the learning phase, the organization chart represented as a tree chart.

10. The method of claim 9, wherein a distance between a reviewer who submits the code review request and any reviewer candidate is based on a tree path metric which is given as:
$${s}_{i} ( {v}_{i} , {v}_{j} ) = \frac{1}{1 + l ( {v}_{i} , {v}_{j} )} = \frac{1}{1 + l ( {v}_{i} , {lca}_{ij} ) + l ( {v}_{j} , {lca}_{ij} )}$$
where vᵢ and v₁ represent two developers, l(vᵢ, vⱼ) is a shortest path between two developers in the organization tree chart, and lcaᵢⱼ is a lowest common ancestor between vᵢ and vⱼ.

11. A non-transitory computer-readable storage medium comprising a computer-readable program for automatically recommending a reviewer for submitted codes, wherein the computer-readable program when executed on a computer causes the computer to perform the steps of:
employing, in a learning phase, an artificial intelligence agent for learning an underlying and contextual structure of code regions;
mapping the code regions into a distributed representation to define code region representations;
employing, in a recommendation phase, the artificial intelligence agent to produce a ranked list of recommended reviewers for any given submitted code review request; and
outputting the ranked list of recommended reviewers to a visualization device.

12. The non-transitory computer-readable storage medium of claim 11, wherein the ranked list of recommended reviewers is based on code review history, coding style, commit history, and employment position of each candidate reviewer.

13. The non-transitory computer-readable storage medium of claim 12, wherein the code review history includes metadata information including select code regions reviewed, amount of source codes reviewed, and feedback and improvement rounds.

14. The non-transitory computer-readable storage medium of claim 11, wherein the code region representations include generating a global code line template dictionary.

15. The non-transitory computer-readable storage medium of claim 14, wherein each code line of a code region is mapped to the global code line template dictionary.

16. The non-transitory computer-readable storage medium of claim 15, wherein a term-frequency inverse document frequency (TFIDF) vector is computed for each code region.

17. The non-transitory computer-readable storage medium of claim 16, wherein two sets of similarity measures are generated, the first similarity measure employed to compute a cosine distance between any two TFIDF vectors and a second similarity measure employed to compute a content similarity based on code line templates.

18. The non-transitory computer-readable storage medium of claim 17, wherein the cosine distance is given as:
$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$
where each Aᵢ and Bᵢ are TFIDF values within a particular code region.

19. The non-transitory computer-readable storage medium of claim 18,
wherein an organization chart is employed in the learning phase, the organization chart represented as a tree chart; and
wherein a distance between a reviewer who submits the code review request and any reviewer candidate is based on a tree path metric which is given as:
$${s}_{i} ( {v}_{i} , {v}_{j} ) = \frac{1}{1 + l ( {v}_{i} , {v}_{j} )} = \frac{1}{1 + l ( {v}_{i} , {lca}_{ij} ) + l ( {v}_{j} , {lca}_{ij} )}$$
where vᵢ and vⱼ represent two developers, l(vᵢ, v₁) is a shortest path between two developers in the organization tree chart, and lcaᵢⱼ is a lowest common ancestor between vᵢ and vⱼ.

20. A system for automatically recommending a reviewer for submitted codes, the system comprising:
a memory; and
one or more processors in communication with the memory configured to:
employ, in a learning phase, an artificial intelligence agent for learning an underlying and contextual structure of code regions;
map the code regions into a distributed representation to define code region representations;
employ, in a recommendation phase, the artificial intelligence agent to produce a ranked list of recommended reviewers for any given submitted code review request; and
output the ranked list of recommended reviewers to a visualization device.
